(19) United States
(12) Patent Application Publication
(10) Pub. No.: US 2013/0281290 A1
(43) Pub. Date: Oct. 24, 2013

(54) NOBLE METAL COLLOID PARTICLES AND NOBLE METAL COLLOID SOLUTION, AND CATALYST FOR OXYGEN REDUCTION

(71) Applicants: Haruko Horiguchi, Mie (JP); Kiyoshi Miyashita, Hyogo (JP)

(72) Inventors: Haruko Horiguchi, Mie (JP); Kiyoshi Miyashita, Hyogo (JP)

(73) Assignee: NIPPON SHEET GLASS COMPANY, LIMITED, Tokyo (JP)

(21) Appl. No.: 13/976,277

(22) PCT Filed: Dec. 21, 2011
(86) PCT No.: PCT/JP2011/007180

§ 371 Date: Jun. 26, 2013

(30) Foreign Application Priority Data
Dec. 28, 2010 (JP) 2010-292116

(51) Int. Cl. H01M 4/92; H01M 4/86

(52) U.S. Cl. CPC H01M 4/92; H01M 4/8652; H01M 4/8657
USPC 502/339; 429/524

(57) ABSTRACT

The noble metal colloidal particles of the present invention are noble metal colloidal particles each including: a Pd colloidal particle; and Pt supported on the surface of the Pd colloidal particle. The noble metal colloidal particles are substantially free from a protective colloid. The Pd colloidal particles have an average particle diameter of 7 to 20 nm. The amount of the Pt supported on the surface of the Pd colloidal particle is 0.05 to 0.65 atomic layer thick, when the amount is expressed as the number of atomic layers of the Pt. The noble metal colloidal solution of the present invention can be obtained by dispersing these noble metal colloidal particles of the present invention in a solvent.

### TECHNICAL FIELD

The present invention relates to noble metal colloidal particles and a noble metal colloidal solution, and an oxygen reduction catalyst.

### BACKGROUND ART

In recent years, fuel cells have attracted attention as a clean energy source. Fuel cells are classified according to the type of electrolyte used in the cells, and include polymer electrolyte fuel cells, phosphoric acid electrolyte fuel cells, alkaline electrolyte fuel cells, molten carbonate fuel cells, and solid oxide fuel cells. Among these fuel cells, in polymer electrolyte fuel cells and phosphoric acid electrolyte fuel cells, platinum (Pt) is used as a catalyst. In these fuel cells, electrode layers (electrode catalyst layers) in which Pt is supported on conductive carbon materials such as carbon black are commonly used (see, for example, Patent Literatures 1 and 2). Pt has high catalytic activity and is suitable as a catalyst for fuel cells.

### CITATION LIST

### Patent Literature

Patent Literature 1 JP 2005-032668 A
Patent Literature 2 JP 2007-123108 A
Patent Literature 3 JP 2006-260909 A

### SUMMARY OF INVENTION

### Technical Problem

Since Pt is rare and expensive, it is desirable to reduce the use of Pt in fuel cells. So, in order to reduce the amount of Pt and allow Pt to exhibit higher activity, various attempts have been made to increase the surface area of Pt particles by reducing the size thereof. However, the reduction in the size of Pt particles may rather cause a decrease in activity because smaller Pt particles are likely to aggregate with each other. In addition, since Pt alone cannot achieve high catalytic performance beyond its own performance, a mere reduction of the amount of Pt causes a decrease in the performance of a fuel cell.

The use of a non-platinum catalyst has also been proposed. For example, Patent Literature 3 discloses a fuel cell in which a palladium (Pd) alloy is used as a catalyst. However, it is difficult for a non-platinum catalyst to exhibit catalytic activity comparable to or higher than that of a Pt catalyst, although the use of the non-platinum catalyst reduces the cost.

It is an object of the present invention to provide noble metal colloidal particles and a noble metal colloidal solution capable of exhibiting catalytic activity comparable to or higher than that of Pt alone, with the use of a smaller amount of Pt. It is another object of the present invention to provide an oxygen reduction catalyst.

### Solution to Problem

The present invention provides noble metal colloidal particles each including: a Pd colloidal particle; and Pt supported on the surface of the Pd colloidal particle. The noble metal colloidal particles are substantially free from a protective colloid. The Pd colloidal particles have an average particle diameter of 7 to 20 nm. The amount of the Pt supported on the surface of the Pd colloidal particle is 0.05 to 0.65 atomic layer thick, when the amount is expressed as the number of atomic layers of the Pt.

The present invention also provides a noble metal colloidal solution containing: a solvent; and the noble metal colloidal particles of the present invention dispersed in the solvent.

The present invention also provides an oxygen reduction catalyst containing noble metal colloidal particles. The noble metal colloidal particles each include: a Pd colloidal particle; and Pt supported on the surface of the Pd colloidal particle. The noble metal colloidal particles are substantially free from a protective colloid. The Pd colloidal particles have an average particle diameter of 7 to 20 nm. The amount of the Pt supported on the surface of the Pd colloidal particle is 0.05 to 0.65 atomic layer thick, when the amount is expressed as the number of atomic layers of the Pt.

### Advantageous Effects of Invention

The amount of Pt contained in the noble metal colloidal particles of the present invention is very small because only 0.05 to 0.65 atomic layer thick of Pt is large enough to be supported on the surface of each Pd colloidal particle. Furthermore, the noble metal colloidal particles of the present invention can achieve catalytic performance comparable to or higher than that of colloidal particles of Pt alone, although the former contains a smaller amount of Pt than the latter. Likewise, the noble metal colloidal solution of the present invention containing these noble metal colloidal particles can achieve catalytic performance comparable to or higher than that of a solution containing Pt alone, with the use of a smaller amount of Pt.

The oxygen reduction catalyst of the present invention contains noble metal colloidal particles capable of achieving catalytic performance comparable to or higher than that of Pt-alone, with the use of a smaller amount of Pt. Therefore, the oxygen reduction catalyst of the present invention is less expensive than a Pt-alone catalyst, and further the use of the oxygen reduction catalyst allows oxygen to be reduced with an efficiency comparable to or higher than the use of a catalyst containing Pt alone.

### BRIEF DESCRIPTION OF DRAWINGS

FIG. 1 is a cross-sectional view of a fuel cell electrode provided with a fuel cell electrode layer containing the oxygen reduction catalyst of the present invention.

FIG. 2 is a cross-sectional view showing one embodiment of a fuel cell including the oxygen reduction catalyst of the present invention.

FIG. 3 is a schematic diagram of an oxygen reduction activity measurement apparatus used in Examples.

FIG. 4 is a graph showing the rates of decrease in dissolved oxygen (oxygen reduction activity levels) measured in Examples.

FIG. 5 is a graph showing zeta potentials measured in Examples.

### DESCRIPTION OF EMBODIMENTS

### First Embodiment

The noble metal colloidal particles of the present invention each include a Pd colloidal particle and Pt supported on the surface of the Pd colloidal particle.

The amount of Pt supported on the surface of the Pd colloidal particle is 0.05 to 0.65 atomic layer thick, when the amount is expressed as the number of atomic layers of the Pt. As stated herein, the “number of atomic layers” means that Pt in an amount corresponding to the thickness of “n” (“n” is a positive number) atomic layers of Pt is present on the surface of a Pd colloidal particle, assuming that the Pd colloidal particle is spherical. The thickness of one atomic layer is equal to the diameter of a Pt atom (0.276 nm). In the noble metal colloidal particles of the present invention, the number of Pt atomic layers is less than 1. Therefore, the number of atomic layers in the noble metal colloidal particles of the present invention is calculated based on the amount of Pt corresponding to the 1 atomic layer thickness. For example, the amount of Pt corresponding to the 0.5 atomic layer thickness is obtained by first calculating the amount of Pt corresponding to the 1 atomic layer thickness and then multiplying the resulting value by 0.5.

In the noble metal colloidal particles of the present invention, the number of Pt atomic layers is 0.05 or more and 0.65 or less. Thereby, the noble metal colloidal particles of the present invention can not only exhibit catalytic activity higher than that of Pd colloidal particles alone but also achieve catalytic performance comparable to or higher than that of particles containing Pt alone. The amount of Pt in the noble metal colloidal particles of the present invention is less than the amount of Pt corresponding to the 1 atomic layer thickness. Therefore, in the noble metal colloidal particles of the present invention, Pt does not cover the entire surface of each Pd colloidal particle, but it is preferable that Pt be supported over an area as large as possible of the surface of the Pd colloidal particle to exhibit its catalytic performance effectively. Therefore, in order to achieve catalytic performance higher than that of a Pt-alone catalyst, the amount of Pt supported on the surface of Pd colloidal particles is preferably 0.1 atomic layer thick or more. In order to further enhance the catalytic activity, the amount of Pt is more preferably 0.15 atomic layer thick or more, and most preferably 0.2 atomic layer thick or more. When the amount of Pt is more than 0.65 atomic layer thick, the catalytic performance is lower than that of a Pt-alone catalyst. When the amount of Pt is small, Pt is supported in the form of islands on the surface of each Pd colloidal particle. Presumably, adjacent Pt islands are joined together as the amount of Pt increases, and when the amount of Pt reaches about 0.65 atomic layer thick, all the Pt islands are joined together. When the amount of Pt further increases, Pt particles are supported to fill the gaps between the Pt islands, which may prevent Pt from exhibiting its catalytic performance effectively. Therefore, in order to achieve catalytic performance higher than that of a Pt-alone catalyst, the amount of Pt is 0.65 atomic layer thick or less, and preferably 0.5 atomic layer thick or less. In order to further enhance the catalytic activity, the amount of Pt is more preferably 0.48 atomic layer thick or less, and most preferably 0.35 atomic layer thick or less.

The Pd colloidal particles have an average particle diameter of 7 to 20 nm. When the average particle diameter of the Pd colloidal particles is less than 7 nm, Pd has poor crystallinity, and Pt supported on the surface of the Pd colloidal particles have poor crystallinity. Furthermore, since electrons are not transferred smoothly between the Pd core and Pt, Pt cannot exhibit its catalytic performance effectively. On the other hand, when the average particle diameter of the Pd colloidal particles is more than 20 nm, the surface area per unit weight of the Pd colloidal particles decreases, resulting in an increase in the number of Pd colloidal particles required to have the same surface area, that is, an increase in the concentration of the Pd colloidal particles. Accordingly, the stability of the colloidal dispersion decreases. As described above, Pd colloidal particles having an average particle diameter of 7 to 20 nm are used to achieve both high crystallinity and high dispersibility of the Pd colloidal particles. As stated herein, the particle diameter of the Pd colloidal particles is that obtained by dynamic light scattering. Specifically, the noninvasive backscatter intensity was measured with a light scattering photometer (DLS-2000, manufactured by Otsuka Electronics Co., Ltd.) to obtain a scattered light intensity-based particle size distribution, and the particle size corresponding to the 50% cumulative volume in that distribution was defined as an average particle diameter.

The noble metal colloidal particles of the present invention are substantially free from a protective colloid. As stated herein, the phrase “substantially free from a protective colloid” means that the concentration of total carbon in the noble metal colloidal solution is about 200 ppm by mass or less, when the content of a protective colloid forming agent in the noble metal colloidal solution is expressed in terms of the carbon content of the protective colloid forming agent. Generally, since a protein or a polymeric substance is used as a protective colloid forming agent, how much protective colloid forming agent is contained in the noble metal colloidal solution can be expressed by the concentration of total carbon in that noble metal colloidal solution. The protective colloid forming agent is described later. The noble metal colloidal particles of the present invention are substantially free from a protective colloid, as described above. Therefore, the contact area between a reacting material (i.e., oxygen to be decomposed, in the present embodiment) and Pt is large enough for Pt to exhibit its catalytic function efficiently.

The noble metal colloidal particles of the present invention each have a structure in which Pt is supported on the surface of a Pd colloidal particle. In a comparison between Pd and Pt, Pt is more electron rich than Pd due to the difference in redox potential. Therefore, the noble metal colloidal particles of the present invention have higher reducing power than colloidal particles of Pt alone, and exhibit higher catalytic activity accordingly.

Next, an example of the method of producing the noble metal colloidal particles of the present invention is described. An example of the method for obtaining a noble metal colloidal solution containing a solvent and the noble metal colloidal particles dispersed in the solvent is described below.

First, a Pd salt solution is prepared. A Pd salt and a reducing agent are added to a solvent. A reaction accelerator for accelerating the reduction reaction of the Pd salt may further be added to the solvent. This Pd salt solution is heated to reduce Pd ions contained in the Pd salt. Thus, a dispersion of Pd colloidal particles (i.e., a Pd colloidal solution) is obtained.

Then, the Pd colloidal solution thus obtained is ion-exchanged with an ion exchange resin to remove impurities from the solution.

Next, a Pt salt is added to the Pd colloidal solution to deposit Pt on the surface of the Pd colloidal particles. A reducing agent and a reaction accelerator may further be added. This solution is heated to reduce Pt ions contained in the Pt salt. Thus, Pt is deposited on the surface of the Pd colloidal particles.

Then, the solution thus obtained is ion-exchanged with an ion exchange resin to remove impurities from the solution. Thus, a noble metal colloidal solution in which Pt is supported on the surface of Pd colloidal particles is obtained.

The Pd salt and Pt salt used in the above-mentioned method are not particularly limited as long as they are readily dissolved in a solvent and reduced with a reducing agent. For example, chlorides, nitrates, sulfates, metal complex compounds, etc. of Pd and Pt can be used.

The solvent is not particularly limited as long as it can dissolve a Pd salt, a Pt salt, a reducing agent, and a reaction accelerator. Water, alcohols, ketones, and ethers can be used as the solvent. Water and alcohols are suitably used from the viewpoint of dissolving the Pd salt and Pt salt well. It is desirable to remove oxygen dissolved in the solvent by boiling the solvent well or introducing an inert gas such as nitrogen gas into the solvent before the reducing agent is added thereto. The addition of the Pd salt or the Pt salt to the solvent containing oxygen makes it difficult for the reduction reaction of Pd or Pt to proceed, and colloidal particles are hardly formed.

The reducing agent is not particularly limited as long as it is dissolved in a solvent and reduces a Pd salt and a Pt salt. As the reducing agent, citric acids, alcohols, carboxylic acids, ketones, ethers, aldehydes, esters, etc. can be used. Two or more of them may be used in combination. Examples of citric acids include citric acid and citrates such as sodium citrate, potassium citrate, and ammonium citrate. Examples of alcohols include methanol, ethanol, 1-propanol, 2-propanol, ethylene glycol, and glycerol. Examples of carboxylic acids include formic acid, acetic acid, fumaric acid, malic acid, succinic acid, aspartic acid, gallic acid, ascorbic acid, and carboxylates thereof. Tannic acid, which is a dehydration product of gallic acid and sugar, also can be used suitably. Examples of ketones include acetone and methyl ethyl ketone. Examples of ethers include diethyl ether. Examples of aldehydes include formaldehyde and acetaldehyde. Examples of esters include methyl formate, methyl acetate, and ethyl acetate. Among them, tannic acid, gallic acid, sodium citrate, ascorbic acid, and salts thereof are particularly preferable because of their high reducing power and ease of handling.

As the reaction accelerator, for example, alkali carbonates such as potassium carbonate, alkali hydrogencarbonates such as sodium hydrogencarbonate, and alkali hydroxides such as lithium hydroxide can be used.

Since the noble metal colloidal particles of the present invention are substantially free from protective colloids, they are produced substantially without using a protective colloid forming agent. As stated herein, a protective colloid forming agent is conventionally a substance added to a colloidal solution to maintain the dispersion stability of colloidal particles. It adheres to the surface of the colloidal particles to form protective colloids. Examples of such a protective colloid forming agent include water-soluble polymeric substances such as polyvinyl alcohol, polyvinyl pyrrolidone, and gelatin, surfactants, and polymeric chelating agents. Since the noble metal colloidal particles of the present invention are negatively charged on their surfaces and electrically repel one another, they can maintain the dispersion stability despite the absence of protective colloids.

The noble metal colloidal particles and the noble metal colloidal solution of the present invention can be obtained by the method described above.

### Second Embodiment

The oxygen reduction catalyst of the present invention contains noble metal colloidal particles. The noble metal colloidal particles each include: a Pd colloidal particle; and Pt supported on the surface of the Pd colloidal particle, and are substantially free from a protective colloid. In these noble metal colloidal particles, the Pd colloidal particles have an average particle diameter of 7 to 20 nm. The amount of the Pt supported on the surface of the Pd colloidal particle is 0.05 to 0.65 atomic layer thick, when the amount is expressed as the number of atomic layers of the Pt.

Since the structure of the noble metal colloidal particles in the present embodiment and the production method thereof are the same as those of the noble metal colloidal particles described in the first embodiment, detailed description is omitted here.

In order for the noble metal colloidal particles to function as an oxygen reduction catalyst more effectively, the amount of Pt supported on the surface of Pd colloidal particle is preferably 0.1 atomic layer thick or more. In order to further enhance the function as an oxygen reduction catalyst, the amount of Pt is more preferably 0.2 atomic layer thick or more. As described also in the first embodiment, when the amount of Pt is more than 0.65 atomic layer thick, the catalytic performance of the noble metal colloidal particles is lower than that of a Pt-alone catalyst. Therefore, in order for the noble metal colloidal particles to function as an oxygen reduction catalyst more effectively than a Pt-alone catalyst, the amount of Pt is 0.65 atomic layer thick or less, and preferably 0.5 atomic layer thick or less. In order to further enhance the function of the oxygen reduction catalyst, the amount of Pt is more preferably less than 0.5 atomic layer thick.

The noble metal colloidal particles may be used, as an oxygen reduction catalyst, in the form of a colloidal solution containing a solvent and the noble metal colloidal particles dispersed therein.

### Third Embodiment

The embodiment of a fuel cell electrode layer and a fuel cell each including the oxygen reduction catalyst of the present invention is described.

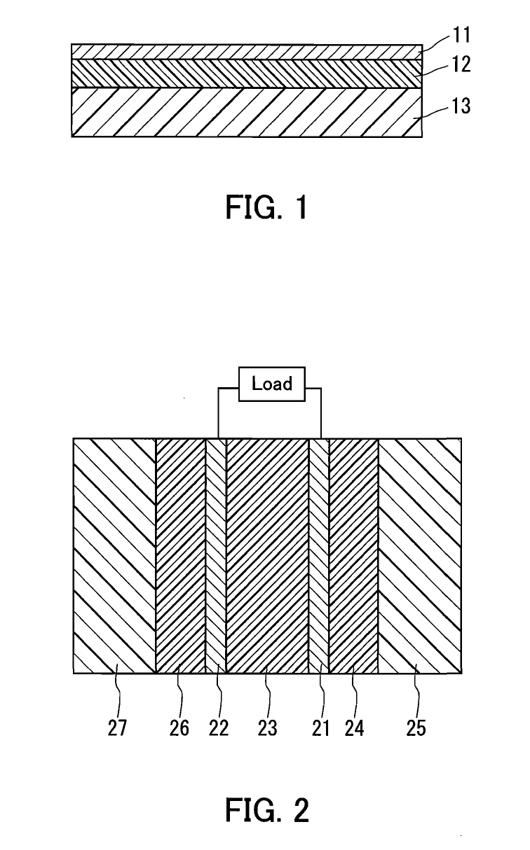

The fuel cell electrode layer of the present embodiment can be used, for example, as an electrode for polymer electrolyte fuel cells and phosphoric acid electrolyte fuel cells. As shown in FIG. 1, the fuel cell electrode has, for example, a three-layer structure including a fuel cell electrode layer 11, a gas diffusion layer 12, and a current collector 13. The fuel cell electrode layer 11 includes an oxygen reduction catalyst, an electron conductor composed of a conductive carbon material on which the oxygen reduction catalyst is supported, and a proton conductor. As the oxygen reduction catalyst, the oxygen reduction catalyst described in the second embodiment can be used. The conductive carbon material serves as a conductor for transferring electrons generated by the action of the oxygen reduction catalyst to an external conductor. The conductive carbon material is, for example, carbon black. As the proton conductor, a material commonly used as a proton conductor in a fuel cell electrode layer can be used.

As the gas diffusion layer 12, a material commonly used as a gas diffusion layer for a fuel cell, such as a mixture of polytetrafluoroethylene and carbon black, is used. The material for the current collector 13 is not particularly limited, and a material commonly used as a current collector for a fuel cell can be used.

The fuel cell of the present embodiment is, for example, a polymer electrolyte fuel cell, and as shown in FIG. 2, includes a cathode electrode layer 21, an anode electrode layer 22, and a polymer electrolyte membrane (electrolyte layer) 23 disposed between the cathode electrode layer 21 and the anode electrode layer 22. The cathode electrode layer 21 includes an oxygen reduction catalyst, an electron conductor composed of a conductive carbon material on which the oxygen reduction catalyst is supported, and a proton conductor. The anode electrode layer 22 includes a catalyst, an electron conductor composed of a conductive carbon material on which the catalyst is supported, and a proton conductor. In the present embodiment, a gas diffusion layer 24 and a current collector 25 are disposed on the surface of the cathode electrode layer 21 that is not in contact with the polymer electrolyte membrane 23. A gas diffusion layer 26 and a current collector 27 are disposed on the surface of the anode electrode layer 22 that is not in contact with the polymer electrolyte membrane 23.

As the oxygen reduction catalyst contained in the cathode electrode layer 21, the oxygen reduction catalyst described in the second embodiment is used. As the catalyst contained in the anode electrode layer 22, platinum, for example, can be used. As the electron conductor and the proton conductor, the same ones as used in the fuel cell electrode described in the present embodiment can be used.

The material of the polymer electrolyte membrane 23 is not particularly limited as long as it is a membrane made of a material commonly used as an electrolyte layer for a polymer electrolyte fuel cell.

### EXAMPLES

Hereinafter, the present invention is described in more detail by way of examples, but the present invention is not limited to the following examples as long as it does not depart from the scope of the present invention.

### Example 1

First, a palladium chloride solution was prepared. 1.68 g of palladium chloride (powder) was dissolved in a mixed solution of 20 mL of 3.65 wt % (1 mol/L) hydrochloric acid aqueous solution and 500 mL of pure water, and then the resulting mixture was diluted to 1 liter with pure water. The resulting solution was used as a 1 g/L palladium precursor solution (1 g/L-Pd precursor).

As reducing agents, sodium citrate and tannic acid were used. Specifically, a 10 wt % sodium citrate solution obtained by diluting sodium citrate with pure water and a 1.43 wt % tannic acid solution obtained by diluting tannic acid with pure water were used. As a reaction accelerator, potassium carbonate was used. Specifically, a 13.82 wt % (1 mol/L) potassium carbonate solution obtained by diluting potassium carbonate with pure water was used.

200 g of 1 g/L palladium precursor solution and 747.8 g of pure water were poured into a 1 L round-bottom flask and mixed together. A small amount of 3.65 wt % (1 mol/L) hydrochloric acid solution was add to adjust the pH of the mixed solution to 2.3. The mixed solution was boiled under reflux for one hour. 15 g of sodium citrate solution, 35 g of tannic acid solution, and 1.25 g of potassium carbonate solution were mixed and added thereto. After these solutions were added, the resulting mixed solution was boiled under reflux for 10 minutes, and then the flask was immersed in ice water and cooled to room temperature. Then, the resulting solution was ion-exchanged with 70 g of ion exchange resin (Amberlite MB-1 (manufactured by Organo Corporation)) to remove impurity ions. Thus, a colloidal solution of Pd colloidal particles that would form the core of Pd—Pt colloidal particles was prepared. The particle diameters of the Pd colloidal particles thus obtained were measured by dynamic light scattering to obtain the average particle diameter thereof. Specifically, the noninvasive backscatter intensity was measured with a light scattering photometer (DLS-2000, manufactured by Otsuka Electronics Co., Ltd.) to obtain a scattered light intensity-based particle size distribution, and the particle size corresponding to the 50% cumulative volume in that distribution was defined as an average particle diameter. The average particle diameter of the Pd colloidal particles of the present example was 10 nm.

The Pd colloidal solution prepared and ion-exchanged as described above was entirely poured into a 1 L flask, and boiled under reflux for 30 minutes under stirring with a stirrer. 0.21 g of 4 wt % chloroplatinic acid aqueous solution as the precursor of Pt that would be supported on the surface of Pd colloidal particles was added to the mixed solution. After the chloroplatinic acid aqueous solution was added and boiled again, 0.7 g of 10 wt % sodium citrate solution was added and boiled under reflux for another hour. Then, the flask was immersed in water and cooled to room temperature. Then, the resulting solution was ion-exchanged with 3 g of ion exchange resin (Amberlite MB-1 (manufactured by Organo Corporation)) to remove impurity ions. Thus, a Pd—Pt colloidal solution was obtained.

In the present example, the weight concentration of Pt was determined so that the amount of Pt contained in each of the Pt—Pd colloidal particles contained in the Pd—Pt colloidal solution was 0.05 atomic layer thick. Specifically, the number of Pd colloidal particles was obtained from the concentration of Pd, and the weight of Pt supported on one Pd colloidal particle was multiplied by the number of Pd colloidal particles to obtain the weight concentration of Pt. For details, see below.

<Number of Core (Pd) Colloidal Particles>

First, the concentration of the Pd colloidal particles was divided by the weight of one Pd colloidal particle to obtain the number of Pd colloidal particles per liter of the solution. Specifically, the number of Pd colloidal particles was obtained in the following manner.

(1) Assuming that the Pd colloidal particles are spherical, the volume of one Pd colloidal particle (V_{Pd}) was calculated using the average particle diameter of 10 nm. The volume (V_{Pd}) was 5.24×10⁻²⁵ m³ per particle.

(2) The weight of one Pd colloidal particle (m_{Pd}) was calculated from the density of Pd (d_{Pd}) and the volume of the Pd colloidal particle (V_{Pd}). The weight (m_{Pd}) was 6.30×10⁻²¹ kg per particle when d_{Pd}=12030 kg/m³ was used.

(3) The number of Pd colloidal particles per liter (N_{Pd}) was calculated by dividing the Pd concentration (M_{Pd}) by the weight of one Pd colloidal particle (m_{Pd}). The number (N_{Pd}=M_{Pd}/m_{Pd}) was 3.18×10¹⁶ per liter. In the present example, the Pd concentration (M_{Pd}) was 200 mg/L.

<Weight Concentration of Pt>

The thickness of Pt was added to the radius of the Pd colloidal particle to obtain the volume of one Pd—Pt colloidal particle (in terms of the spherical volume). The volume of the Pd colloidal particle was subtracted from the resulting volume to obtain the volume of Pt alone. This volume of Pt was multiplied by the density of Pt to obtain the weight of Pt required for one Pd—Pt colloidal particle. Then, the resulting weight was multiplied by the number of Pd colloidal particles per liter of the solution to determine the weight concentration of Pt. In this example, the amount of Pt is 0.05 atomic layer thick. First, the weight concentration of 1 atomic layer-thick Pt was determined in the following manner. Then, the weight concentration of 1 atomic layer-thick Pt was multiplied by 0.05 to obtain the weight concentration of Pt required to form a 0.05 atomic layer. Specifically, the weight concentration of Pt was obtained in the following manner.

(1) First, for the case where the number of Pt atomic layers is 1, the volume of the Pd—Pt colloidal particle (V_{Pd—Pt}) was calculated using 10 nm as the average particle diameter of the Pd colloidal particles and 0.276 nm (2.76×10⁻¹⁶ m) as the diameter of a Pt atom. The volume (V_{Pd—Pt}) was 6.15×10⁻²⁵ m³ per particle.

(2) The volume of the Pd colloidal particle (V_{Pd}) was subtracted from the volume of the Pd—Pt colloidal particle (V_{Pd—Pt}) to obtain the volume of Pt alone (V_{Pt}). The volume (V_{Pt}) was 9.16×10⁻²⁶ m³ per particle.

(3) The volume of Pt (V_{Pt}) was multiplied by the density of Pt (d_{Pt}) to obtain the weight of Pt (m_{Pt}) required for one Pd—Pt colloidal particle. The weight (m_{Pt}) was 1.96×10⁻²¹ kg per particle when d_{Pt}=21450 kg/m³ was used.

(4) The weight of the Pt (m_{Pt}) in one Pd—Pt colloidal particle was multiplied by the number of Pt colloidal particles per liter (N_{Pt}) to obtain the weight concentration of Pt (M_{Pt}) required. The weight concentration of Pt (M_{Pt}) was 6.24×10⁻⁵ kg/L=62.4 mg/L.

(5) The weight concentration of 1 atomic layer-thick Pt was multiplied by 0.05 to obtain the weight concentration of Pt required to form a 0.05 atomic layer.

In the present example, the Pd—Pt colloidal solution was prepared so that the weight concentration of Pt was 62.4 mg/L×0.05≈3.1 mg/L.

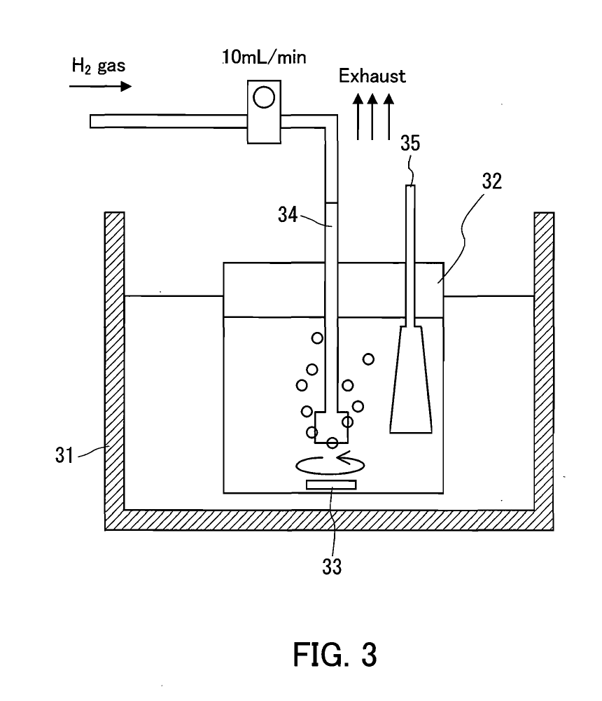

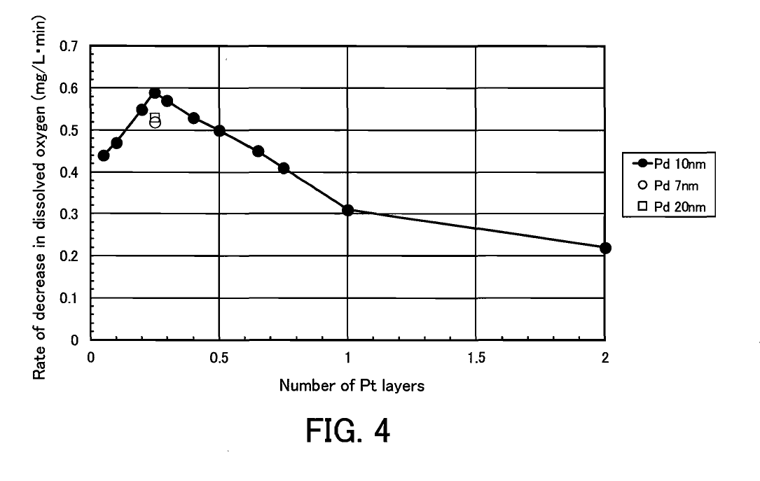

For the Pd—Pt colloidal solution thus obtained, the oxygen reduction activity was evaluated. The oxygen reduction activity was evaluated by measuring the rate of reaction between hydrogen and dissolved oxygen in water into which the Pd—Pt colloidal solution was poured. Specifically, the oxygen reduction activity was measured using an apparatus shown in FIG. 3. A beaker 32 containing 500 mL of pure water was set in a constant temperature bath 31, and the temperature of the water was set to 40° C. The pure water in the beaker 32 was stirred with a stirrer 33 and heated to 40° C. Hydrogen gas was flowed through a glass filter (gas filter tube) 34 at a hydrogen flow rate of 10 mL/min. The glass filter 34 was placed in the beaker 32 so that the glass filter 34 is located at an upper central position in the beaker 32 (directly above the stirrer 33). The dissolved oxygen concentration was measured with a portable dissolved oxygen meter (manufactured by HACH) 35. When the amount of dissolved oxygen reached about 5.5 mg/L, 200 μL of the Pd—Pt colloidal solution was poured into the beaker 32, and then the measurement was started. The rate of decrease in dissolved oxygen (i.e., the rate of decrease [mg/L·min] for 3 minutes after the dissolved oxygen concentration reaches 4.2 mg/L) was defined as a measure of oxygen reduction activity. The activity of the Pd—Pt colloidal solution of the present example was evaluated based on this rate of decrease. Table 1 and the graph of FIG. 4 show the evaluation result.

For the Pd—Pt colloidal solution, the zeta potential was also measured.

A zeta potential refers to a part of the potential difference in an electrical double layer formed at the interface between a solid and a liquid and is effectively involved in electrokinetic phenomena. The zeta potential is used as a measure of the stability of colloidal dispersions. As the absolute value of the zeta potential increases, the repulsion between particles increases and thus the stability of the particles also increases. On the other hand, as the absolute value of the zeta potential approaches zero, the particles are more likely to aggregate.

As a method for measuring the zeta potential, electrophoretic light scattering measurement (laser Doppler flowmetry) was used. This is a technique for measuring the migration velocity of particles using the properties of the particles that move at a certain velocity in an electric field according to the zeta potential on the surface of the particles so as to determine the potential.

When an external electric field is applied to a system in which charged particles are dispersed, the particles electrophoretically migrate (move) toward an electrode. This electrophoretic velocity is proportional to the zeta potential of the particles. Thus, the zeta potential can be determined by measuring the electrophoretic velocity.

The electrophoretic velocity of the particles is proportional to the frequency shift of light scattered by the electrophoretically migrating particles exposed to laser radiation. Therefore, the shift (Δv) is measured, and thereby the electrophoretic velocity (V) of the particles is calculated using the following equation (1):

Δv={2Vn·sin(θ/2)}/λ (1)

where n is the refractive index of a medium, λ is the wavelength of the laser light, and θ is the scattering angle.

Based on the electrophoretic velocity (V) thus obtained, the zeta potential (ξ) is calculated using the following equation (2):

ξ={4Πη(V/E)}/∈ (2)

where η is the viscosity of the medium, ∈ is the dielectric constant of the medium, and E is the electric field.

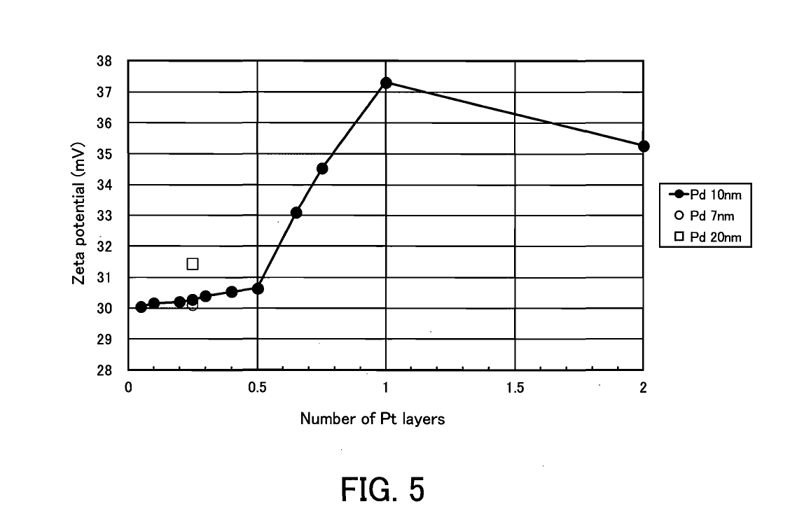

ELS-6000 manufactured by Otsuka Electronics Co., Ltd. was used for the measurement. The Pd—Pt colloidal solution of this example was diluted to about five times with pure water. Thus, a measurement sample was obtained. The measurement was performed three times under the conditions of 20° C. and pH 5 to obtain potentials, and the average thereof was calculated as the zeta potential. Table 1 and the graph of FIG. 5 show the result.

### Example 2

A Pd—Pt colloidal solution was prepared in the same manner as in Example 1, except that 746.9 g of pure water was used for the preparation of a Pd colloidal solution, 0.41 g of Pt precursor solution (chloroplatinic acid aqueous solution) was used, and 1.41 g of sodium citrate solution was used for the reduction of Pt. 70 g of ion exchange resin was used after the Pd colloidal solution was prepared, and 4 g of ion exchange resin was used after Pt was supported on the Pd colloidal particles.

The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.1 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 3

A Pd—Pt colloidal solution was prepared in the same manner as in Example 1, except that 745.1 g of pure water was used for the preparation of a Pd colloidal solution, 0.83 g of Pt precursor solution (chloroplatinic acid aqueous solution) was used, and 2.83 g of sodium citrate solution was used for the reduction of Pt. 70 g of ion exchange resin was used after the Pd colloidal solution was prepared, and 8 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.2 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 4

A Pd—Pt colloidal solution was prepared in the same manner as in Example 1, except that 744.4 g of pure water was used for the preparation of a Pd colloidal solution, 1.00 g of Pt precursor solution (chloroplatinic acid aqueous solution) was used, and 3.39 g of sodium citrate solution was used for the reduction of Pt. 70 g of ion exchange resin was used after the Pd colloidal solution was prepared, and 9 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.25 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 5

A Pd—Pt colloidal solution was prepared in the same manner as in Example 1, except that 743.3 g of pure water was used for the preparation of a Pd colloidal solution, 1.24 g of Pt presursor solution (chloroplatinic acid aqueous solution) was used, and 4.23 g of sodium citrate solution was used for the reduction of Pt. 70 g of ion exchange resin was used after the Pd colloidal solution was prepared, and 12 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.3 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 6

A Pd—Pt colloidal solution was prepared in the same manner as in Example 1, except that 741.4 g of pure water was used for the preparation of a Pd colloidal solution, 1.66 g of Pt presursor solution (chloroplatinic acid aqueous solution) was used, and 5.65 g of sodium citrate solution was used for the reduction of Pt. 70 g of ion exchange resin was used after the Pd colloidal solution was prepared, and 15 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.4 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 7

A Pd—Pt colloidal solution was prepared in the same manner as in Example 1, except that 739.9 g of pure water was used for the preparation of a Pd colloidal solution, 2.01 g of Pt presursor solution (chloroplatinic acid aqueous solution) was used, and 6.84 g of sodium citrate solution was used for the reduction of Pt. 70 g of ion exchange resin was used after the Pd colloidal solution was prepared, and 18 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.5 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 8

A Pd—Pt colloidal solution was prepared in the same manner as in Example 1, except that 736.9 g of pure water was used for the preparation of a Pd colloidal solution, 2.69 g of Pt precursor solution (chloroplatinic acid aqueous solution) was used, and 9.18 g of sodium citrate solution was used for the reduction of Pt. 70 g of ion exchange resin was used after the Pd colloidal solution was prepared, and 24 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.65 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 9

A Pd—Pt colloidal solution was prepared in the same manner as in Example 1, except that 740.8 g of pure water was used for the preparation of a Pd colloidal solution, 35 g of tannic acid solution was only used as a Pd reducing agent, 17.5 g of potassium carbonate solution was used as a reaction accelerator, 1.51 g of Pt precursor solution (chloroplatinic acid aqueous solution) was used, and 5.16 g of sodium citrate solution was used for the reduction of Pt. 100 g of ion exchange resin was used after the Pd colloidal solution was prepared, and 14 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 7 nm. In the present example, the weight concentration of Pt in the Pd—Pt colloidal solution was determined so that the amount of Pt was 0.25 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Example 10

A Pd—Pt colloidal solution was prepared in the same manner as in Example 1, except that 762.6 g of pure water was used for the preparation of a Pd colloidal solution, 35 g of tannic acid solution was only used as a Pd reducing agent, 0.15 g of potassium carbonate solution was used as a reaction accelerator, 0.5 g of Pt precursor solution (chloroplatinic acid aqueous solution) was used, and 1.72 g of sodium citrate solution was used for the reduction of Pt. 70 g of ion exchange resin was used after the Pd colloidal solution was prepared, and 5 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 20 nm. In the present example, the weight concentration of Pt in the Pd—Pt colloidal solution was determined so that the amount of Pt was 0.25 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 1 and the graphs of FIGS. 4 and 5 show the results.

### Comparative Example 1

A Pd—Pt colloidal solution was prepared in the same manner as in Example 1, except that 735.1 g of pure water was used for the preparation of a Pd colloidal solution, 3.11 g of Pt precursor solution (chloroplatinic acid aqueous solution) was used, and 10.58 g of sodium citrate solution was used for the reduction of Pt. 70 g of ion exchange resin was used after the Pd colloidal solution was prepared, and 26 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 0.75 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 2 and the graphs of FIGS. 4 and 5 show the results.

### Comparative Example 2

A Pd—Pt colloidal solution was prepared in the same manner as in Example 1, except that 730.5 g of pure water was used for the preparation of a Pd colloidal solution, 4.14 g of Pt precursor solution (chloroplatinic acid aqueous solution) was used, and 14.11 g of sodium citrate solution was used for the reduction of Pt. 70 g of ion exchange resin was used after the Pd colloidal solution was prepared, and 36 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 1 atomic layer thick.

For the Pd—Pt colloidal solution thus obtained, the oxygen reduction activity and the zeta potential were measured in the same manner as in Example 1. Table 2 and the graphs of FIGS. 4 and 5 show the results.

### Comparative Example 3

A Pd—Pt colloidal solution was prepared in the same manner as in Example 1, except that 713.1 g of pure water was used for the preparation of a Pd colloidal solution, 8.09 g of Pt precursor solution (chloroplatinic acid aqueous solution) was used, and 27.59 g of sodium citrate solution was used for the reduction of Pt. 70 g of ion exchange resin was used after the Pd colloidal solution was prepared, and 68 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 10 nm. In the present example, the weight concentration of Pt in the Pd—Pt colloidal solution was determined so that the amount of Pt was 2 atomic layers thick. Considering that Pt atoms are cubic close-packed, the thickness of 2 atomic layers of Pt was determined to be (1+3½/2)×the diameter of a Pt atom (0.276 nm).

For the Pd—Pt colloidal solution thus obtained, the oxygen reduction activity and the zeta potential were measured in the same manner as in Example 1. Table 2 and the graphs of FIGS. 4 and 5 show the results.

### Comparative Example 4

A Pd—Pt colloidal solution was prepared in the same manner as in Example 1, except that 736.1 g of pure water was used for the preparation of a Pd colloidal solution, 35 g of tannic acid solution was only used as a Pd reducing agent, 20 g of potassium carbonate solution was used as a reaction accelerator, 2.02 g of Pt precursor solution (chloroplatinic acid aqueous solution) was used, and 6.87 g of sodium citrate solution was used for the reduction of Pt. 100 g of ion exchange resin was used after the Pd colloidal solution was prepared, and 18 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 5 nm. In the present example, the weight concentration of Pt in the Pd—Pt colloidal solution was determined so that the amount of Pt was 0.25 atomic layer thick. The weight concentration of Pt was determined in the same manner as in Example 1.

For the Pd—Pt colloidal solution thus obtained, the oxygen reduction activity and the zeta potential were measured in the same manner as in Example 1. Table 2 and the graphs of FIGS. 4 and 5 show the results.

### Comparative Example 5

A Pd—Pt colloidal solution was prepared in the same manner as in Example 1, except that 763.6 g of pure water was used for the preparation of a Pd colloidal solution, 35 g of tannic acid solution was only used as a Pd reducing agent, potassium carbonate solution as a reaction accelerator was not used, 0.33 g of Pt precursor solution (chloroplatinic acid aqueous solution) was used, and 1.11 g of sodium citrate solution was used for the reduction of Pt. 70 g of ion exchange resin was used after the Pd colloidal solution was prepared, and 4 g of ion exchange resin was used after Pt was supported on the Pd colloidal particles. The average particle diameter of the Pd colloidal particles was obtained in the same manner as in Example 1. In the present example, the average particle diameter of the Pd colloidal particles was 30 nm. In the present example, the weight concentration of Pt in the Pd—Pt colloidal solution was determined so that the amount of Pt was 0.25 atomic layer thick. The weight concentration of Pt was determined in the same manner as in Example 1.

For the Pd—Pt colloidal solution thus obtained, the oxygen reduction activity and the zeta potential were measured in the same manner as in Example 1. However, the Pd—Pt colloidal solution of the present comparative example had poor dispersibility, and the particles aggregated and precipitated for a short time after the solution was prepared. Therefore, stable values could not be measured.

### Comparative Example 6

In Comparative Example 6, a Pd colloidal solution containing no Pt supported on the surface of Pd colloidal particles was prepared. The Pd colloidal solution was prepared in the same manner as in Example 1, except that 750.0 g of pure water was used for the preparation of the Pd colloidal solution. The average particle diameter of the Pd colloidal particles was obtained in the same manner as in Example 1. In the present example, the average particle diameter of the Pd colloidal particles was 10 nm.

For the Pd colloidal solution thus obtained, the oxygen reduction activity and the zeta potential were measured in the same manner as in Example 1. Table 2 and the graphs of FIGS. 4 and 5 show the results.

### Comparative Example 7

In Comparative Example 7, a Pt colloidal solution was prepared. First, 26.6 g of 4 wt % chloroplatinic acid was poured into a 1 L round-bottom flask, and pure water was added to obtain 951.8 g of an aqueous solution. A cooling tube was attached to the flask, and the solution was boiled under reflux for 60 minutes while being heated by a mantle heater. 48.2 g of 10 wt % sodium citrate aqueous solution was added thereto and boiling under reflux was continued. After about 5 minutes, the solution quickly turned from light orange to black. The resulting solution was further refluxed for one hour. Thus, a Pt colloidal solution was prepared. The Pt colloidal solution thus prepared was ion-exchanged with an ion exchange resin (Amberlite MB-1 (manufactured by Organo Corporation)) to remove impurities. The average particle diameter of the Pt colloidal particles was obtained in the same manner as for that of the Pd colloidal particles in Example 1. The average particle diameter of the Pt colloidal particles was 3 nm.

For the Pt colloidal solution thus obtained, the oxygen reduction activity and the zeta potential were measured in the same manner as in Example 1. Table 2 and the graphs of FIGS. 4 and 5 show the results.

The results of Examples 1 to 10 are shown collectively in Table 1, and the results of Comparative Examples 1 to 7 are shown collectively in Table 2. FIG. 4 show the graph of the rates of decrease in dissolved oxygen in Examples 1 to 10 and Comparative Examples 1 to 3. FIG. 5 show the graph of the zeta potentials in Examples 1 to 10 and Comparative Examples 1 to 3.

TABLE 1

| Items | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Colloid type | Pd—Pt | Pd—Pt | Pd—Pt | Pd—Pt | Pd—Pt | Pd—Pt | Pd—Pt | Pd—Pt | Pd—Pt | Pd—Pt |
| Pd average particle | 10 | 10 | 10 | 10 | 10 | 10 | 10 | 10 | 7 | 20 |
| diameter (nm) | | | | | | | | | | |
| Pd concentration | 200 | 200 | 200 | 200 | 200 | 200 | 200 | 200 | 200 | 200 |
| (mg/L) | | | | | | | | | | |
| Number of Pt layers | 0.05 | 0.1 | 0.2 | 0.25 | 0.3 | 0.4 | 0.5 | 0.65 | 0.25 | 0.25 |
| (layers thick) | | | | | | | | | | |
| Pt concentration | 3.1 | 6.2 | 12.5 | 15.6 | 18.7 | 25 | 31.2 | 40.6 | 22.8 | 7.6 |
| (mg/L) | | | | | | | | | | |
| Rate of decrease in | 0.44 | 0.47 | 0.55 | 0.59 | 0.57 | 0.53 | 0.50 | 0.45 | 0.52 | 0.53 |
| dissolved oxygen | | | | | | | | | | |
| (mg/(L · min.)) | | | | | | | | | | |
| Zeta potential (mV) | 30.05 | 30.16 | 30.21 | 30.28 | 30.39 | 30.54 | 30.64 | 33.10 | 30.12 | 31.44 |

TABLE 2

| | Com. | Com. | Com. | Com. | Com. | Com. | Com. |
|---|---|---|---|---|---|---|---|
| Items | Ex. 1 | Ex. 2 | Ex. 3 | Ex. 4 | Ex. 5 | Ex. 6 | Ex. 7 |
| Colloid type | Pd—Pt | Pd—Pt | Pd—Pt | Pd—Pt | Pd—Pt | Pd | Pt |
| | | | | | | 10 nm | 3 nm |
| Pd average particle | 10 | 10 | 10 | 5 | 30 | 10 | — |
| diameter (nm) | | | | | | | |
| Pd concentration | 200 | 200 | 200 | 200 | 200 | 200 | — |
| (mg/L) | | | | | | | |
| Number of Pt layers | 0.75 | 1 | 2 | 0.25 | 0.25 | — | — |
| (layers thick) | | | | | | | |
| Pt concentration | 46.8 | 62.4 | 121.9 | 30.4 | 4.9 | — | 350 |
| (mg/L) | | | | | | | |
| Rate of decrease in | 0.41 | 0.31 | 0.22 | 0.40 | — | 0.40 | 0.43 |
| dissolved oxygen | | | | | | | |
| (mg/(L · min.)) | | | | | | | |
| Zeta potential (mV) | 34.54 | 37.31 | 35.27 | 29.65 | — | 30.09 | 50.04 |

The Pd—Pt colloidal solutions of Examples 1 to 8 and Comparative Examples 1 to 3 containing Pd colloidal particles having the same average particle diameter of 10 nm, the Pd colloidal solution of Comparative Example 6 containing no Pt supported, and the Pt colloidal solution of Comparative Example 7 were compared for their oxygen reduction activity levels. The rate of decrease in dissolved oxygen in the Pd colloidal solution containing no Pt supported was 0.40 mg/L·min, while the rate of decrease in dissolved oxygen in the Pt colloidal solution was 0.43 mg/L·min. So in the graph of FIG. 4, the range of the amount of Pt in which the rates of decrease in dissolved oxygen were higher than these values was determined. As a result, it was confirmed that higher rates of decrease in dissolved oxygen were obtained when the amount of Pt was in the range of 0.05 to 0.65 atomic layer thick. On the other hand, when the amount of Pt was outside this range, the rate of decrease in dissolved oxygen was lower than that of the Pt colloidal solution. These results confirmed that the Pd—Pt colloidal solutions containing Pt in an amount of 0.05 to 0.65 atomic layer thick exhibited oxygen reduction activity comparable to or higher than that of the Pt colloidal solution, with the use of a smaller amount of Pt.

Among Examples containing Pd colloidal particles with an average particle diameter of 10 nm, Example 4, in which the amount of Pt was 0.25 atomic layer thick, exhibited the highest rate of decrease in dissolved oxygen, that is, the highest oxygen reduction activity. The rate of decrease in dissolved oxygen in Example 4 was compared with the rates of decrease in dissolved oxygen in Example 9 and Example 10, in which the amounts of Pt were the same (0.25 atomic layer thick) as that in Example 4 but the average particle diameters of Pd colloidal particles were different (7 nm in Example 9 and 20 nm in Example 10) from that in Example 4. As a result, the rates of decrease in dissolved oxygen in Examples 9 and 10 were slightly lower than the rate in Example 4 but sufficiently higher than the rates in Comparative Examples.

### INDUSTRIAL APPLICABILITY

Since the noble metal colloidal particles and the noble metal colloidal solution of the present invention can achieve high catalytic activity efficiently with a smaller amount of Pt, they can be used as oxygen reduction catalysts in a wide variety of applications such as fuel cells.

1. Noble metal colloidal particles each comprising: a Pd colloidal particle; and Pt supported on a surface of the Pd colloidal particle, wherein
the noble metal colloidal particles are substantially free from a protective colloid,
the Pd colloidal particles have an average particle diameter of 7 to 20 nm, and
an amount of the Pt supported on the surface of the Pd colloidal particle is 0.05 to 0.65 atomic layer thick, when the amount is expressed as the number of atomic layers of the Pt.

2. A noble metal colloidal solution comprising: a solvent; and noble metal colloidal particles dispersed in the solvent, wherein
the noble metal colloidal particles are noble metal colloidal particles according to claim 1.

3. An oxygen reduction catalyst comprising noble metal colloidal particles, wherein
the noble metal colloidal particles each comprising: a Pd colloidal particle; and Pt supported on a surface of the Pd colloidal particle,
the noble metal colloidal particles are substantially free from a protective colloid,
the Pd colloidal particles have an average particle diameter of 7 to 20 nm, and
an amount of the Pt supported on the surface of the Pd colloidal particle is 0.05 to 0.65 atomic layer thick, when the amount is expressed as the number of atomic layers of the Pt.
